(19) United States
(12) Patent Application Publication
(10) Pub. No.: US 2011/0176860 A1
(43) Pub. Date: Jul. 21, 2011

(54) STRUCTURE OF CONNECTOR FOR ALUMINUM EXTRUSION FRAME

(76) Inventor: RUEI-HSING LIN, Taipei Hsien (TW)

(21) Appl. No.: 12/690,940

(22) Filed: Jan. 21, 2010

(51) Int. Cl. F16B 2/14; F16C 11/00

(52) U.S. Cl. 403/119; 403/409.1

(57) ABSTRACT

A structure of connector is provided for connecting at least one aluminum extrusion frame, which forms at least one channel. The connector includes a base, two fixer members, a link bar, and a depression block. The base forms a through slot and the two fixer members are pivotally connected to the base on opposite sides of the through slot. The link bar is received in and pivotally connected to the through slot of the base and an opposite end of the link bar is pivotally connected to the depression block. As such, the connector is insertable into the channel of the aluminum extrusion frame. By actuating the depression block to drive the two fixer members to move in an outward direction to abut against side walls of the channel, efficient securing the connector to the aluminum extrusion frame can be realized.

### TECHNICAL FIELD OF THE INVENTION

The present invention generally relates to a structure of connector for connecting aluminum extrusion frames, and more particularly to a structure of connector that is applicable to interconnect at least one aluminum extrusion frame for reducing the time and labor needed for assembling the aluminum extrusion frames and also eliminating the need of fastening tools to be used in the process of assembling the aluminum extrusion frames. The present invention use the features of the connector that can be tightly fixed in a channel defined in an aluminum extrusion frame and/or can be readily released from the channel of the aluminum extrusion frame to provide a connector structure that allows for interconnected assembling/disassembling of at least one aluminum extrusion frame in an efficient, safe, and easy manner.

### DESCRIPTION OF THE PRIOR ART

Frames that are commonly used to build up partitions in an exhibition sit, or that are used to build up an exhibition rack or shelf, or that are used to form a wall-mounted frame for suspending articles thereon, or that are used to form office partitions, or that are used to form frames of aluminum windows/doors, are often made up of frame members of aluminum extrusions. Those frame members can be assembled and jointed together through horizontal connection, vertical connection, T-shaped connection, cruciform connection. A conventional way of jointing two frames is illustrated in FIG. 8 of the attached drawings. A regular aluminum extrusion frame A forms a plurality of channels A1. Each channel A1 is delimited by opposing side walls A11 and each side wall A11 has a top end forming an inwardly-projecting flange A12. With such a structure, when aluminum extrusion frames A are to be assembled, a connection board B has opposite ends that are respectively received in the channels A1 of the aluminum extrusion frames A. The two end portions of the connection board B respectively form a plurality of locking holes B1. Bolts C are respectively set into the locking holes B1 of the connection board B. When these bolts C are respectively screwed in the locking holes B1 of the connection board B, the connection board B is forced to move upward within the channel A1 until the connection board B is set tightly against the flanges A12 of the channel A1 and the aluminum extrusion frame A is securely fixed. This completes the assembling of two aluminum extrusion frames A.

However, although the above discussed conventional method can connect two aluminum extrusion frames A, in the practical operation of assembling aluminum extrusion frame, tightening the bolts C to the connection board B for assembling/disassembling is time- and labor-consuming, making it difficult to realize efficient and easy assembling. Further, the assembling/disassembling operation of the conventional method requires use of fastening tools (such as screwdrivers). In addition, in tightening the bolts C to the connection board B, the rotation of the bolts C often cause abrasion and damage to the surface structure and appearance of the aluminum extrusion frame A. Thus, in repeated process of assembling/disassembling the aluminum extrusion frame A, due to the fact that the damaged connection board B cannot be re-used, waste of material may be caused.

### SUMMARY OF THE INVENTION

In view of the above discussed problems, the present invention aims to provide a structure of connector for connecting aluminum extrusion frames, by which the problems of consuming a great amount of time and human labor in assembling/disassembling operation by tightening bolts to a connection board and interconnecting the aluminum extrusion frames with the connection board in the process of assembling aluminum extrusion frames in the conventional way can be overcome and by which the use of fastening tools (such as screwdrivers) in assembling/disassembling operation is eliminated, and abrasion and damage caused on the surface structure and appearance of the aluminum extrusion frame in the process of assembling/disassembling can be prevented.

According to the present invention, a structure of connector for connecting aluminum extrusion frame comprises a base, two fixer members, a link bar, and a depression block. The base forms a through slot and the two fixer members are pivotally connected to the base on opposite sides of the through slot. The link bar is received in and pivotally connected to the through slot of the base and an opposite end of the link bar is pivotally connected to the depression block. As such, the connector is insertable into the channel defined in an aluminum extrusion frame. By actuating the depression block to drive the two fixer members for outward pushing, the two fixer members are caused to move in an outward direction to abut against side walls of the channel so as to realize efficient securing the connector to the channel of the aluminum extrusion frame. Further, to disassemble an aluminum extrusion frame that is assembled with other members, the depression block is moved outward to cause the link bar to separate from the position between the two fixer members, by which the two fixer members are allowed to disengage from the side walls of the channel of the aluminum extrusion frame for efficiently removing the connector from the channel of the aluminum extrusion frame.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a connector constructed in accordance with the present invention.

FIG. 2 is an exploded view of the connector of the present invention.

FIG. 3 is a top plan view of the connector of the present invention.

FIG. 4-1 is a cross-sectional view illustrating an operation of the connector of the present invention.

FIG. 4-2 is a cross-sectional view illustrating another operation of the connector of the present invention.

FIG. 5 is a schematic view illustrating connection of the connector of the present invention to aluminum extrusion frame.

FIG. 6 is a cross-sectional view taken along line A-A′ of FIG. 5.

FIG. 7 is a cross-sectional view illustrating the connector of the present invention set in an aluminum extrusion frame.

FIG. 8 is a schematic view illustrating the assembling of a conventional aluminum extrusion frame.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

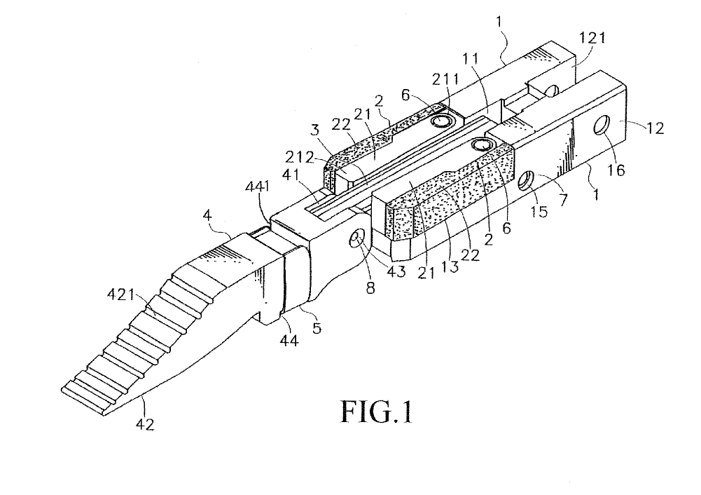

Referring to FIGS. 1 2, 3, and 5, the present invention provides a structure of connector for connecting at least one aluminum extrusion frame 9. The aluminum extrusion frame 9 forms at least one channel 91, and the connector is designed for insertion into the channel 91 of the aluminum extrusion frame 9. The connector comprises a base 1, two fixer members 2, a link bar 3, and a depression block 4.

The base 1 has an end portion, which forms a through slot 11 having an open end, and an opposite end portion forming a connection section 12. The base 1 also forms recessed sections 13 respectively on opposite side walls of the through slot 11. Further, the connection section 12 forms a through slot 121 having an open end. The base 1 forms first through holes 14 that are respectively in communication with the recessed sections 13, second through holes 15 that are in communication with the through slot 11, and third through holes 16 that are in communication with the through slot 121 of the connection section 12.

The two fixer members 2 are respectively received, in a pivotally connected manner, in the recessed sections 13 of the base 1, and are respectively located on opposite sides of the through slot 11 of the base 1. Each of the fixer members 2 comprises a holding block 21 and an anti-skidding block 22. The holding block 21 has an end portion, which forms a pivot hole 211 corresponding to a respective one of the first through holes 14 of the base 1, and an opposite end portion forming an expansion section 212, whereby the holding block 21 has a width at a location corresponding to the expansion section 212 that is greater than a width at a location corresponding to the pivot hole 211. The anti-skidding block 22 is arranged on an outer side of the holding block 21 in a direction away from the through slot 11 of the base 1.

The link bar 3 has an end portion, which forms a first connection section 31 that is received in and pivotally connected to the through slot 11 of the base 1, and an opposite end portion, which forms a second connection section 32 that extends out of the through slot 11 of the base 1, whereby the link bar 3 is arranged between the two fixer members 2. The first connection section 31 of the link bar 3 forms a first pivot hole 311 corresponding to the second through holes 15 of the base 1. The second connection section 32 of the link bar 3 forms a second pivot hole 321. The link bar 3 forms, on portions thereof adjacent to the two fixer members 2, first inclined angles 33 and also forms, on a portion of the second connection section 32 that is distant from the first inclined angles 33, a second inclined angle 34.

The depression block 4 has an end portion, which forms a through slot 41 that receives and is pivotally connected to the second connection section 32 of the link bar 3, and an opposite end portion, which forms a depression and securing section 42. The depression block 4 forms pivot holes 43 in communication with the through slot 41. The pivot holes 43 correspond to the second pivot hole 321 of the second connection section 32 of the link bar 3. The depression block 4 forms an upper-side fitting slot 44 between the through slot 41 and the depression and securing section 42, whereby an inverted U-shaped resilient element 5 is fit and fixed in the upper-side fitting slot 44 to correspondingly extend into a lower-side fitting slot 441 so as to allow the depression block 4 to be concealed in the channel 91 and also provide the function of loosening and losing prevention and securing. Further, the depression block 4 forms a sloping surface 421 on an opposite surface of the depression and securing section 42.

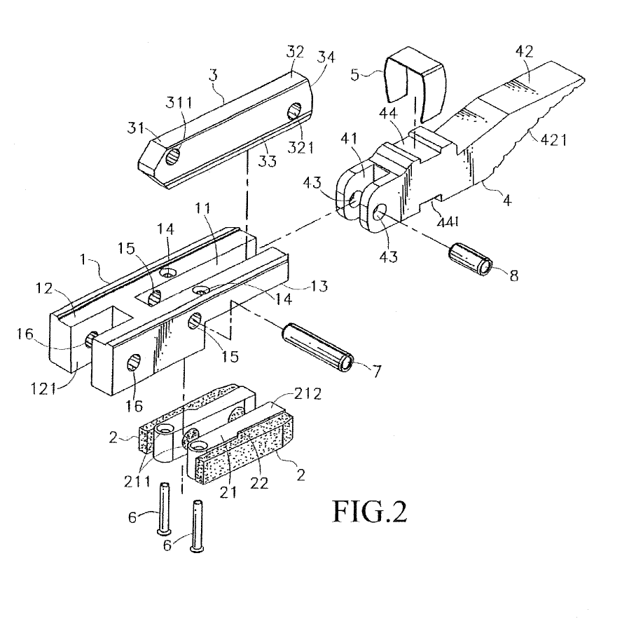

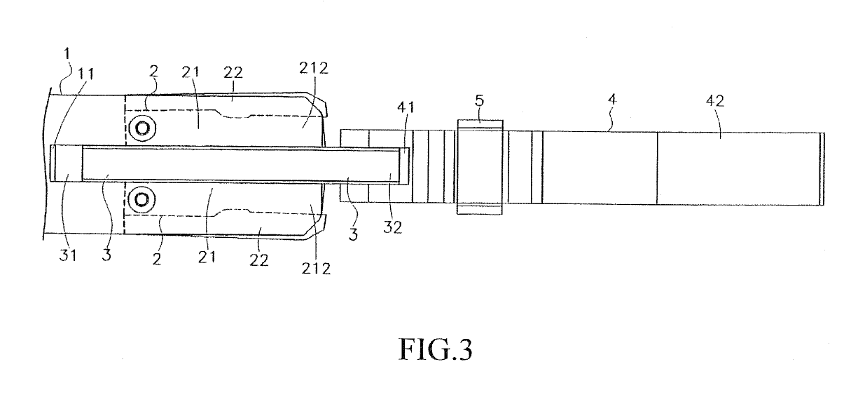

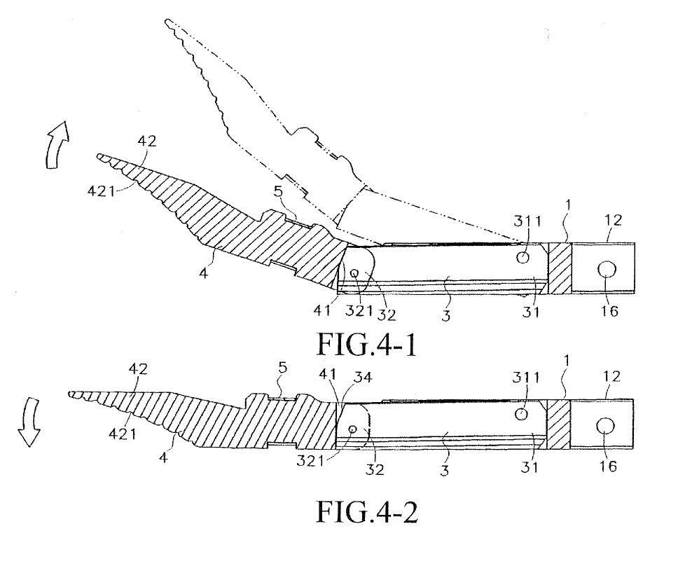

Referring to FIGS. 4-1 and 4-2, the two fixer members 2 are set, in opposition to each other, in recessed sections 13 of the base 1 to have the pivot holes 211 of the holding blocks of the fixer members 2 in alignment with the first through holes 14 of the base 1, so that first pivots 6 can be respectively received through the pivot holes 211 of the fixer members 2 and the first through holes 14 of the base 1, thereby allowing the fixer members 2 to be angularly movable in the recessed sections 13 of the base 1 about rotation centers defined by the first pivots 6. The link bar 3 is received in the through slot 11 of the base 1 and located between the two fixer members 2. The first pivot hole 311 of the first connection section 31 of the link bar 3 is set in alignment with the second through holes 15 of the base 1 to receive a second pivot 7 through the second through holes 15 of the base 1 and the first pivot hole 311 of the link bar 3, thereby allowing the link bar 3 to move on the base 1 in a swinging manner about a rotation center defined by the second pivot 7 and thus swinging between the through slot 11 of the base 1 and the two fixer members 2. The depression block 4 is arranged on the second connection section 32 of the link bar 3 with the pivot holes 43 of the depression block 4 in alignment with the second pivot hole 321 of the second connection section 32 of the link bar 3 to receive a third pivot 8 through the pivot holes 43 of the depression block 4 and the second pivot hole 321 of the link bar 3, so that the depression block 4 is movable in a swinging manner on the link bar 3 about a rotation center defined by the third pivot 8.

As such, when the depression block 4 is lifted upward, the depression block 4 is moved to abut against the second connection section 32 of the link bar 3 thereby driving the link bar 3 upward and thus making the link bar 3 away from a position between the two fixer members 2 and away from the through slot 11 of the base 1. On the other hand, when the depression block 4 is depressed downward, the depression block 4 is set to abut against the second connection section 32 of the link bar 3 to drive the link bar 3 downward, bringing the link bar 3 to a position within the through slot 11 of the base 1 and between the two fixer members 2, and where the link bar 3 is set in engagement with the two fixer members 2.

The fixer members 2 comprise expansion sections 212 respectively formed on ends of the holding blocks 21 thereof, so that the holding block 21 has a width at a location corresponding to the expansion sections 212 that is greater than a width at a location corresponding to the pivot holes 211. As such, when the link bar 3 is set in a location in engagement with the two fixer members 2, the expansion sections 212 of the holding blocks 21 are forcely moved outward to cause the anti-skidding blocks 22 to move in an outward direction, thereby making the anti-skidding blocks 22 of the fixer members 2 projecting out of the recessed sections 13 of the base 1. Further, the anti-skidding blocks 22 of the fixer members 2 are of a property of resilient deformability and can be coupled to the holding blocks 21 through adhesives, fitting, or integral molding.

The link bar 3 forms, on portions thereof adjacent to the two fixer members 2, first inclined angles 33, which facilitates the link bar 3 to move into the position between the two fixer members 2. Further, the link bar 3 forms, on a portion of the second connection section 32 that is distant from the first inclined angles 33, a second inclined angle 34, whereby when the depression block 4 is lifted upward, the depression block 4 can be set at a position abutting against the second inclined angle 34 to set a predetermined limited angular position in the lifting operation.

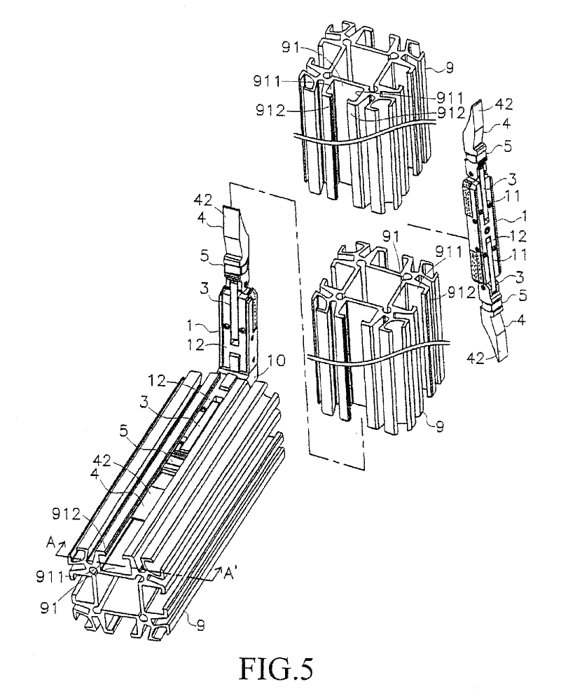

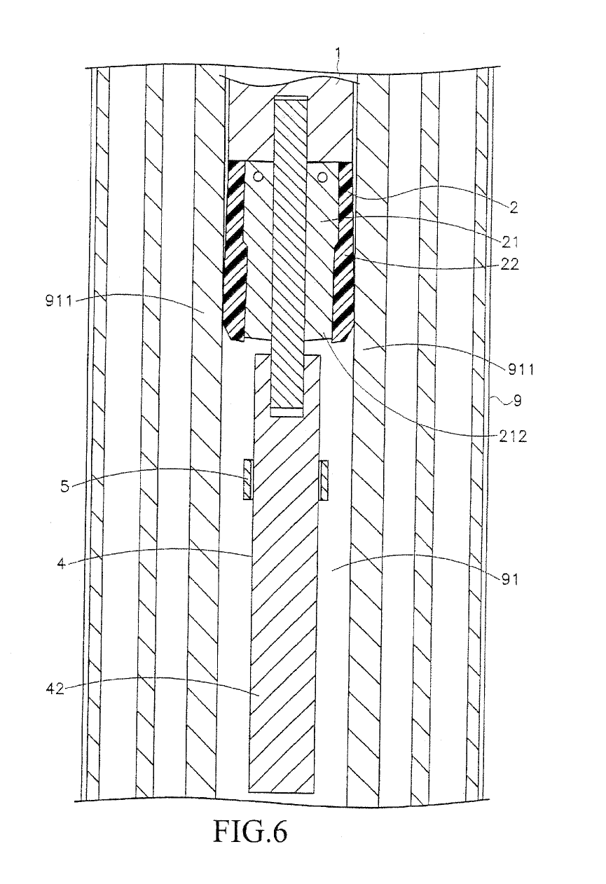

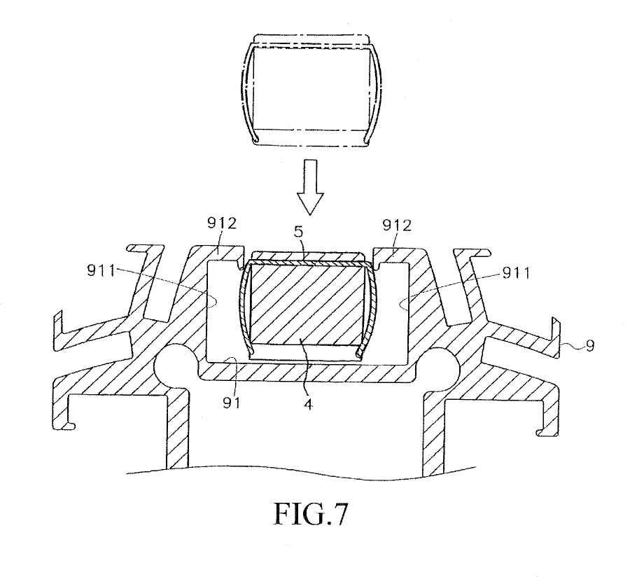

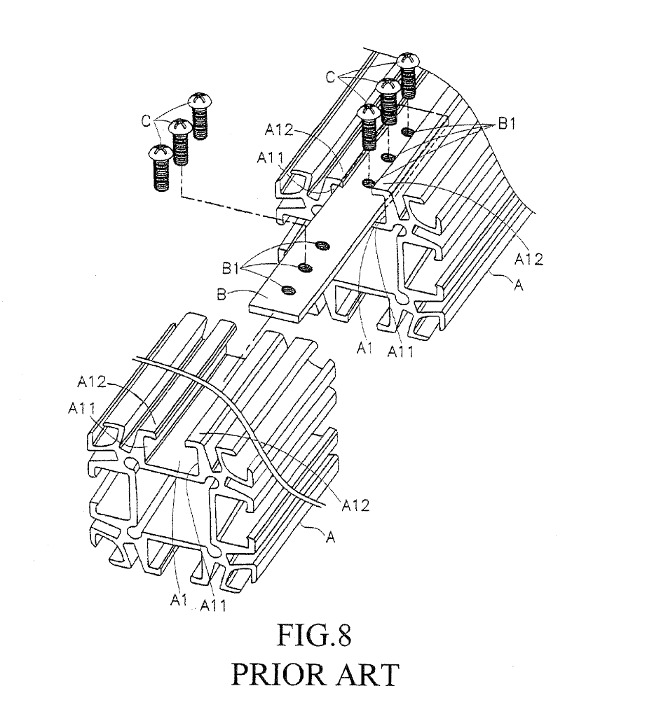

Referring to FIGS. 5, 6, and 7, the aluminum extrusion frame 9 is provided with a plurality of channels 91. Each channel 91 is delimited by opposing side walls 911. Top ends of the side walls 911 form inward-projecting side flanges 912. The connector according to the present invention can be set in different assembling configuration to mate the configuration that the aluminum extrusion frames 9 are to be assembled together, wherein the connection section 12 of the base 1 is connected to a coupler 10 that is of a desired configuration of various possible configurations (such as: in-line configuration, L-shaped configuration, T-shaped configuration, and crossciform configuration) so that a number of bases 1 can be coupled to each other. Alternatively, the connection section 12 of one base 1 can be integrally molded with another base 1 to realize connection of multiple bases 1 in various configurations and orientations.

As such, when aluminum extrusion frames 9 are to be assembled together, the base 1 of a connector is inserted into the channel 91 of one aluminum extrusion frame 9. With the base 1 received in the channel 91 of the aluminum extrusion frame 9. by depressing down the depression block 4, the depression block 4 is set to abut against the second connection section 32 of the link bar 3 and drive the link bar 3 downward so that the link bar 3 is set to a position within the through slot 11 of the base 1 and between the two fixer members 2. The link bar 3 is thus set in engagement with and pushes the two fixer members 2 outward to have the anti-skidding blocks 22 of the two fixer members 2 projecting out of the recessed sections 13 of the base 1 to allow the anti-skidding blocks 22 of the two fixer members 2 to tightly abut aginast the side walls 911 of the channel 91 of the aluminum extrusion frame 9, thereby realizing fast and securely couple the base 1 of the connector to the channel 91 of the aluminum extrusion frame 9. In this way, a number of aluminum extrusion frames 9 can be efficiently assembled together. Further, to disassemble the aluminum extrusion frames 9 that are assembled together, within the channel 91 of each of the aluminum extrusion frames 9, the depression block 4 is lifted upward to set the depression block 4 against the second connection section 32 of the link bar 3 for driving the link bar 3 upward, making the link bar 3 separating from the position between the two fixer members 2 thereby setting the two fixer members 2 in a released condition within the channel 91 of the aluminum extrusion frame 9 and thus realizing fast seperation of the base 1 of the connector from the channel 91 of each of the aluminum extrusion frames 9 to allow for efficient disassembling of the aluminum extrusion frames 9.

Further, when the depression block 4 is located inside the channel 91 of the aluminum extrusion frame 9, the inverted U-shaped resilient element 5 provided on the depression block 4 is set in engagement with the side flanges 912 of the channel 91 of the aluminum extrusion frame 9 to securely set the depression block 4 within the channel 91 of the aluminum extrusion frame 9 and also to provide the function of loosening and losing prevention and securing to ensure the depression block 4 does not undesiredly fall out of the channel 91.

Therefore, according to the technical features of the present invention, efficient assembling/disassembling of at least one aluminum extrusion frame 9 is realized through tightly fixing the base 1 of a connector to a channel 91 formed in the aluminum extrusion frame 9 and/or releasing the base 1 from the channel 91 of the aluminum extrusion frame 9. In this way, the time- and effort-consuming operation of conventionally assembling aluminum extrusion frames by setting bolts in connection boards and securing the connection boards to the aluminum extrusion frames can be eliminated and tools (such as screwdrivers) that are needed in carrying out assembling/disassembling of the conventional aluminum extrusion frames and that may inadvertently cause abrasion and damage to the structure and surfaces of the aluminum extrusion frames are no long needed in the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A connector for connecting at least one aluminum extrusion frame, wherein the aluminum extrusion frame forms at least one channel and the connector is insertable into the channel of the aluminum extrusion frame, the connector comprising:
a base, which has an end portion, which forms a through slot, and an opposite end portion forming a connection section, the base forming recessed sections respectively on opposite side walls of the through slot;
two fixer members, which are respectively received, in a pivotally connected manner, in the recessed sections of the base and are respectively located on opposite sides of the through slot of the base;
a link bar, which has an end portion, which forms a first connection section that is pivotally connected to the through slot of the base, and an opposite end portion, which forms a second connection section that extends out of the through slot of the base, the link bar being arranged between the two fixer members and
a depression block, which has an end portion, which forms a through slot that is pivotally connected to the second connection section of the link bar, and an opposite end portion, which forms a depression and securing section.

2. The connector according to claim 1, wherein each of the fixer members comprises a holding block and an anti-skidding block, the holding block having an end portion forming an expansion section, the anti-skidding block being arranged on an outer side of the holding block in a direction away from the through slot of the base.

3. The connector according to claim 1, wherein the link bar has portions adjacent to the two fixer members and forming first inclined angles, the second connection section having a portion that is distant from the first inclined angles and forms a second inclined angle.

4. The connector according to claim 1, wherein the depression block forms an upper-side fitting slot and a lower-side fitting slot between the through slot thereof and the depression and securing section.

5. The connector according to claim 4, wherein an inverted U-shaped resilient element is fit and fixed in the upper-side fitting slot to correspond to the lower-side fitting slot.
